(19) United States
(12) Patent Application Publication
(10) Pub. No.: US 2009/0285276 A1
(43) Pub. Date: Nov. 19, 2009

(54) Apparatus, method, and computer program product for demodulation

(75) Inventor: Markku J. Heikkila, Oulu (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 12/222,784

(22) Filed: Aug. 15, 2008

(30) Foreign Application Priority Data
May 15, 2008 (FI) 20085457

(51) Int. Cl. H04L 27/01

(52) U.S. Cl. 375/232

(57) ABSTRACT

The invention relates to an apparatus comprising: an estimator configured to estimate a channel response; a determiner configured to determine an equalizer coefficient vector; a calculator configured to calculate a symbol amplitude by using the equalizer coefficient vector and the estimated channel response; a determiner configured to determine a weighting factor by using the symbol amplitude; an estimator configured to estimate soft bits; and a weighter configured to weight the estimated soft bits by using the weighting factor for scaling the estimated soft bits to a predetermined dynamic range in a manner enabling their presentation using a predetermined limited numerical accuracy.

### FIELD

The invention relates to an apparatus, method, and computer program product for demodulation.

### BACKGROUND

The following description of background art may include insights, discoveries, understandings or disclosures, or associations together with disclosures not known to the relevant art prior to the present invention but provided by the invention. Some such contributions of the invention may be specifically pointed out below, whereas other such contributions of the invention will be apparent from their context.

In detectors of communications systems, symbol estimates are typically transformed to quantized soft bits. The sign of a soft bit carries information on the most likely transmitted bit and the magnitude of the soft bit carries information on the reliability of the estimated bit. Soft bits are typically presented as log-likelihood ratios (LLR).

In many systems, such as an Evolved Universal Mobile Telecommunications system (E-UTRA), besides other reasons for high variance of soft bit values, a signal-to-noise ratio supported by a soft bit generator is about 30 dB, which further increases the dynamic range of LLR soft bits.

### BRIEF DESCRIPTION

According to an aspect of the present invention, there is provided an apparatus comprising: an estimator configured to estimate a channel response; a determiner configured to determine an equalizer coefficient vector; a calculator configured to calculate a symbol amplitude by using the equalizer coefficient vector and the estimated channel response; a determiner configured to determine a weighting factor by using the symbol amplitude; an estimator configured to estimate soft bits; and a weighter configured to weight the estimated soft bits by using the weighting factor for scaling the estimated soft bits in a manner enabling their presentation using a predetermined limited numerical accuracy.

According to another aspect of the present invention, there is provided a method comprising: estimating a channel response; determining an equalizer coefficient vector; calculating a symbol amplitude by using the equalizer coefficient vector and the estimated channel response; determining a weighting factor by using the symbol amplitude; estimating soft bits; and weighting the estimated soft bits by using the weighting factor for scaling the estimated soft bits in a manner enabling their presentation using a predetermined limited numerical accuracy.

According to another aspect of the present invention, there is provided an apparatus comprising: means for estimating a channel response; means for determining an equalizer coefficient vector means for calculating a symbol amplitude by using the equalizer coefficient vector and the estimated channel response; means for determining a weighting factor by using the symbol amplitude; means for estimating soft bits; and means for weighting the estimated soft bits by using the weighting factor for scaling the estimated soft bits in a manner enabling their presentation using a predetermined limited numerical accuracy.

According to another aspect of the present invention, there is provided computer program product embodied on a computer-readable medium and encoding a computer program of instructions for executing a computer process comprising: calculating a symbol amplitude by using a predetermined equalizer coefficient vector and a predetermined channel response; determining a weighting factor by using the symbol amplitude; estimating soft bits; and weighting the estimated soft bits by using the weighting factor for scaling the estimated soft bits in a manner enabling their presentation using a predetermined limited numerical accuracy.

### LIST OF DRAWINGS

Embodiments of the present invention are described below, by way of example only, with reference to the accompanying drawings, in which

FIG. 1 illustrates an example of a radio system;

FIG. 2 is a flow chart; and

FIG. 3 illustrates an example of an apparatus.

### DESCRIPTION OF EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

Embodiments are applicable to any user terminal, server, corresponding component, and/or to any communication system or any combination of different communication systems that support required functionality.

The protocols used, the specifications of communication systems, servers and user terminals, especially in wireless communication, develop rapidly. Such development may require extra changes to an embodiment. Therefore, all words and expressions should be interpreted broadly and they are intended to illustrate, not to restrict, embodiments.

In the following, different embodiments will be described using, as an example of a system architecture whereto the embodiments may be applied, an architecture based on Evolved UMTS terrestrial radio access (E-UTRA, UMTS=Universal Mobile Telecommunications System) without restricting the embodiment to such an architecture, however.

Many different radio protocols to be used in communications systems exist. Some examples of different communication systems include the Universal Mobile Telecommunications System (UMTS) radio access network (UTRAN or E-UTRAN), Long Term Evolution (LTE, the same as E-UTRA), Wireless Local Area Network (WLAN), Worldwide Interoperability for Microwave Access (WiMAX), Bluetooth®, Personal Communications Services (PCS), and systems using ultra-wideband (UWB) technology.

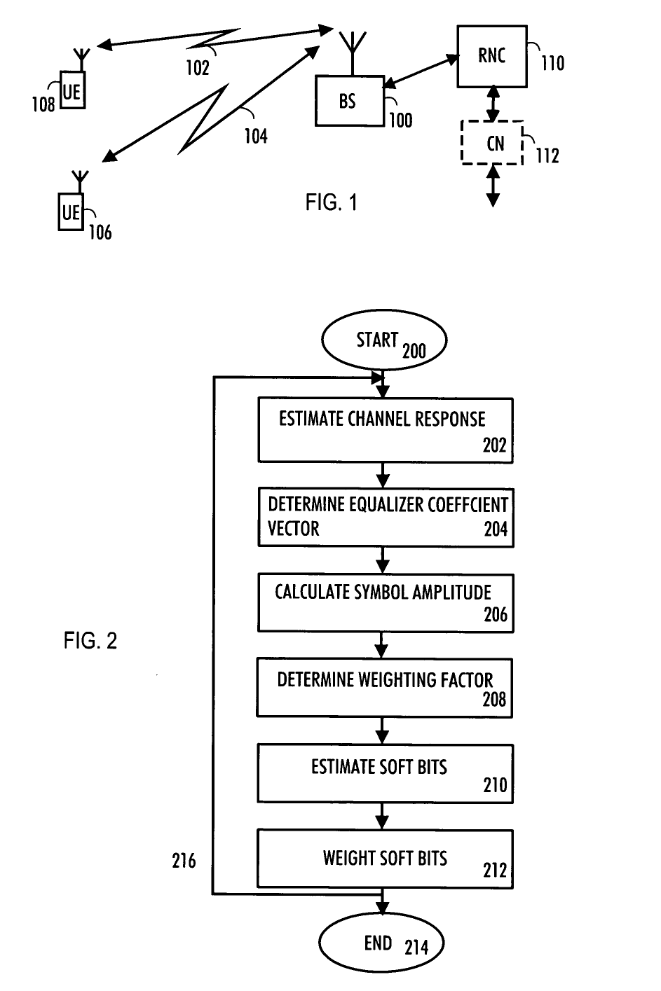

FIG. 1 is a simplified system architecture only showing some elements and functional entities, all being logical units whose implementation may differ from what is shown. The connections shown in FIG. 1 are logical connections; the actual physical connections may be different. It is apparent to a person skilled in the art that the systems also comprise other functions and structures. It should be appreciated that the functions, structures, elements and the protocols used in or for group communication, are irrelevant to the actual invention. Therefore, they need not to be discussed in more detail here.

FIG. 1 shows a part of a radio access network of E-UTRA.

The communications system is a cellular radio system which comprises a base station (or node B) 100, which has bi-directional radio links 102 and 104 to user devices 106 and 108. The user devices may be fixed, vehicle-mounted or portable. The user devices 106 and 108 may refer to portable computing devices. Such computing devices include wireless mobile communication devices operating with or without a subscriber identification module (SIM), including, but not limited to, the following types of devices: mobile phone, multimedia device, personal digital assistant (PDA), handset.

The base station includes transceivers, for instance. From the transceivers of the base station, a connection is provided to an antenna unit that establishes bi-directional radio links to the user devices. The base station is further connected to a controller 110, a radio network controller (RNC), which transmits the connections of the devices to the other parts of the network. The radio network controller controls in a centralized manner several base stations connected to it. The radio network controller is further connected to a core network 112 (CN). Depending on the system, the counterpart on the CN side can be a mobile services switching center (MSC), a media gateway (MGW) or a serving GPRS (general packet radio service) support node (SGSN), etc.

It should be noted that in future radio networks, the functionality of an RNC may be distributed among (possibly a subset of) base stations.

The embodiments are not, however, restricted to the system given as an example but a person skilled in the art may apply the solution to other communication systems provided with the necessary properties. Different radio protocols may be used in the communication systems to which embodiments of the invention are applicable. The radio protocols used are irrelevant regarding the embodiments of the invention.

The communication system is also able to communicate with other networks, such as a public switched telephone network or the Internet.

Before an information-bearing signal is transmitted to a communication channel, some kind of modulation is typically carried out to produce a signal that can be accommodated by the channel. In a receiver, a demodulator is designed to remove the modulation.

Next, an embodiment is further explained by means of FIG. 2. The method starts is block 200.

In block 202, a channel frequency response is estimated. The estimation of a channel frequency response or a transfer function is based on a known sequence of bits which is often called a training sequence. Several methods for channel frequency response estimation are provided.

In block 204, a filter coefficient vector of an equalizer is determined. The implementation of the embodiment does not restrict the selection of the method for this determination or the selection of the equalizer.

A channel equalizer aims to correct distortion of a signal occurred on the radio channel (typically inter symbol interference). The equalizer can be implemented for example by using a linear finite impulse response (FIR) type filter. Such an equalizer can be optimized using various optimization criteria. An example of such a filter optimization is a linear minimum mean square error (LMMSE). An embodiment uses a linear minimum mean square error (LMMSE) detector which is suitable for both single-stream and multiple-input-multiple-output (MIMO) systems. It can also be used as a part of serial interference cancellation (SIC) or parallel interference cancellation (PIC) detectors.

Equalization typically requires information on a channel response. In OFDM or OFDMA based systems, such as E-UTRAN, equalization is typically performed by using a frequency domain signal, which can be obtained by computing a Fast Fourier Transform (FFT) of a time-sampled received signal. Therefore, the channel response needed for equalization is the channel frequency response. In some other systems, such as the UMTS, time-domain equalization is typically used and the required channel response is thus the channel impulse response.

The information on a channel response may be provided by channel estimation. Usually the channel estimation is based on a known sequence of symbols, which is often called a training sequence. Equalization without separate channel estimation (e.g., with linear, decision-feedback, blind equalizers) is also an option.

In block 206, a symbol amplitude A is determined by using a predetermined filter coefficient vector and the estimated channel response.

A=w^{H}h, (1)
wherein
w is an LMMSE filter coefficient vector,
H denotes a Hermitian vector or matrix (a conjugate transpose vector or matrix), and
h denotes a channel response estimate (vector).

The filter coefficient vector is a coefficient vector of an equalization filter. The channel frequency response estimate is determined in block 202.

In block 208, a weighting factor is determined by using the symbol amplitude.
The weighting factor is of the form:

$$\frac{{c}_{1}}{{c}_{2} - α A} , \qquad ( 2 )$$

wherein
c₁ is a selectable parameter,
c₂ is another selectable parameter,
α is yet another selectable parameter, and
A is a symbol amplitude.

The using of a weighting factor provides a possibility to scale soft bit estimates to prevent or at least diminish saturation or rounding to zero when the soft bits are later quantized to a limited word length and/or to obtain suitably formed soft information (absolute values of soft bits) to be used in channel decoding.

Typically, c₂ is set to 1, and α is obtainable by Monte Carlo simulations. Parameter c₁ is designed to compensate for the fact that for instance 64-QAM (quadrature amplitude modulation) is typically used only with high signal-to-noise ratios, which tends to lead to larger absolute soft bit values than for instance when 16-QAM or QPSK (quadrature phase shift keying) are used. Thus, as an example, c₁ may be set to 1, for QPSK, 0.5 for 16-QAM and 0.25 for 64-QAM.

Further improvements are obtainable by setting c₁ according to a signal-to-noise ratio (SNR). For example, if the signal-to-noise ratio is known to be above a certain threshold value, which indicates large average absolute values for the soft bits, it is beneficial to use a smaller value for c₁ than when SNR is known to be at least relatively low.

A is typically between 0 to 1 if LMMSE equalization is applied. Value 1 is obtainable in an at least partly noiseless situation indicating a very high reliability of the estimates. Thus c₂ is set to 1, since the denominator presented in Equation (2) is not allowed to obtain a negative value. The term α may be set to be <1 for a soft bit compression to limit the range of the soft bits by preventing the denominator of Equation (2) from obtaining very small values. This further prevents loss of soft information in a last quantization step of the soft bits.

Division in the Equation (2) may be implemented by using a hardware divider or with the aid of a look-up table (LUT) which may store a limited number of precomputed values to avoid performing the division.

In block 210, soft bits are estimated.

An embodiment uses a demodulator for obtaining soft bit estimates. A demodulator may also be called a symbol-to-bits mapper. An option for a demodulator is a soft slicer or a slicer demodulator. Soft bits include a bit decision and information on the reliability of the decision.

A constellation diagram is a generally used representation of a signal modulated by a digital modulation method. A plurality of modulation methods exists: quadrature amplitude modulation (QAM), phase-shift keying (PSK), frequency-shift keying (FSK), amplitude-shift keying (ASK), etc. The constellation diagram is typically used to illustrate the signal as a two-dimensional scatter diagram in the complex plane (circular or rectangular) at symbol sampling instants. Such a constellation diagram may also be used to show symbols selectable by a given modulation scheme as points marked as bit sequences, usually called symbols, in the complex plane. Measured constellation diagrams can be used to recognize the type of interference and distortion in a received signal.

In a receiver, the demodulator is usually given an estimate of a received symbol that typically has been affected by the channel and/or the receiver itself. In this embodiment, the receiver is assumed to be divided into an equalizer, which removes at least some of the channel distortion, and a demodulator. The purpose of the demodulator is to select the bit sequence actually transmitted. The selection may be carried out by searching for the point on the constellation diagram which is closest (in a Euclidean distance sense) to that of the received symbol. Estimates for transmitted bits are then obtainable by utilizing information about bit sequences represented by the constellation points.

This method, however, does not generate soft information, that is, reliability information on the bits, which is generally required for good channel decoder performance. To map symbol estimates to soft bits, one of the simplest methods is to apply slicer demodulation where bit position-specific decision thresholds may be used. The thresholds vary according to the modulation method used (that is according to the number of constellation points) and according to a symbol amplitude.
For example, 16-QAM soft bits can be calculated as:

\hat{b}₁=Re(\hat{s})

\hat{b}₂=Im(\hat{s})

\hat{b}₃=AT−|Re(\hat{s})|′

\hat{b}₄=AT−|Im(\hat{s})| (3)
wherein
Re denotes a real part,
ŝ denotes a symbol estimate,
Im denotes an imaginary part,
A denotes a symbol amplitude,
T denotes a decision threshold,
∥ denotes an absolute value, and
\hat{b}ᵢ, i=1,2,3,4 denotes bit estimates of bit position i.

The soft bit generation explained above may be interpreted geometrically as computing distances to bit position-specific decision thresholds. When bit positions are 1 and 2, coordinate axes are also decision thresholds. When bit positions are 3 and 4, a decision threshold is T which may be pre-scaled by symbol amplitude A.

In block 212, the estimated soft bits are weighted by using the weighting factor for scaling the estimated soft bits in a manner enabling their presentation using a predetermined limited numerical accuracy while obtaining soft information in a form suitable for channel decoding. Numerical accuracy typically refers to a dynamic range (the range from the minimum value to the maximum value) and/or resolution, which may be limited due to a limited number of bits usable for presentation of soft bit values in a fixed-point or floating-point format. The required numerical accuracy may vary case by case.
The weighting of the soft bit estimate \hat{b}ᵢ may be expressed as follows:

$${\tilde{b}}_{i} = \frac{{c}_{1}}{{c}_{2} - α A} {\hat{b}}_{i} , \qquad ( 4 )$$

wherein
\hat{b}ᵢ denotes a soft bit estimate,
c₁ is a selectable constant,
c₂ is another selectable constant,
α is yet another selectable constant, and
A is a symbol amplitude.

After weighting, the soft bits of Equation (4) may be quantized using either linear or non-linear quantization.

The embodiment ends in block 214. The embodiment is repeatable. Arrow 216 depicts one option for repetition.

The steps/points, signaling messages and related functions described above in FIG. 2 are in no absolute chronological order, and some of the steps/points may be performed simultaneously or in an order different from the given one. Other functions can also be executed between the steps/points or within the steps/points and other signaling messages sent between the illustrated messages. Some of the steps/points or part of the steps/points can also be left out or replaced by a corresponding step/point or part of the step/point.

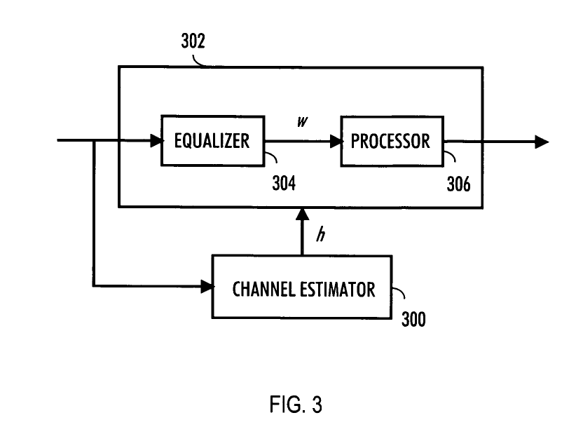

FIG. 3 depicts an example of an apparatus.

An apparatus comprises an estimator configured to estimate a channel frequency response, a determiner configured to determine an equalizer coefficient vector, a calculator configured to calculate a symbol amplitude by using the equalizer coefficient vector and the estimated channel response, a determiner configured to determine a weighting factor by using the symbol amplitude, an estimator configured to estimate soft bits, and a weighter configured to weight the estimated soft bits by using the weighting factor for scaling the estimated soft bits to a predetermined dynamic range.

Another apparatus comprises means 300 for estimating a channel frequency response, means 304 for determining an equalizer coefficient vector, means 306 for calculating a symbol amplitude by using the equalizer coefficient vector w and the estimated channel response h, means 306 for determining a weighting factor by using the symbol amplitude, means 306 for estimating soft bits and means 306 for weighting the estimated soft bits by using the weighting factor for scaling the estimated soft bits to a predetermined dynamic range.

For this purpose, the apparatus of FIG. 3 comprises a channel estimator 300, and a detector 302 including an equalizer 304 and a processor 306. The apparatus may also be implemented as one module. The module/modules are typically implemented as a computer program.

The channel estimator 300 typically estimates a channel frequency response or impulse response (h). The estimation of channel frequency response or transfer function is based on a known sequence of symbols which is often called a training sequence. Several methods for channel frequency response estimation are provided.

The equalizer 304 determines an equalizer coefficient vector (w) and provides an equalized output signal. Several kinds of equalizers exist.

The equalizer can be implemented for example by using a linear finite impulse response (FIR) type filter. Such an equalizer can be optimized using various optimization criteria. An example of such a filter optimization is a linear minimum mean square error (LMMSE).

Equalization typically requires information on a channel response. The information may be provided by channel estimation. Usually the channel estimation is based on a known sequence of symbols, which is often called a training sequence. Equalization without separate channel estimation (e.g., with linear, decision-feedback, blind equalizers) is also an option.

The processor typically includes several modules configured to carry out the following processes: determination of a symbol amplitude A by using a predetermined filter coefficient vector (w) and the estimated channel response (h) (e.g. Equation 1), determination of a weighting factor by using the symbol amplitude (e.g. Equation 2), estimation of soft bits (e.g. Equation 3) and weighting the estimated soft bits by using the weighting factor for scaling the estimated soft bits to a predetermined dynamic range (e.g. Equation 4).

An embodiment uses a demodulator for obtaining soft bit estimates. The demodulator is usually given an estimate of a received symbol that typically has been affected by the channel and/or the receiver itself. In this embodiment, the receiver is divided into an equalizer, which removes at least some of the channel distortion, and a demodulator. The purpose of the demodulator is to select the bit sequence actually transmitted. The selection may be carried out by searching for the point on the constellation diagram which is closest (in a Euclidean distance sense) to that of the received symbol. Estimates for transmitted bits are then obtainable by utilizing information about bit sequences represented by the constellation points.

The processor may also be one module. The module/modules are typically implemented as a computer program.

It should be appreciated that the apparatus may comprise other units used in or for the example of FIG. 3. However, they are irrelevant to the embodiment and, therefore, they need not to be discussed in more detail here.

The apparatus may be a user terminal which is a piece of equipment or a device that associates, or is arranged to associate, the user terminal and its user with a subscription and allows a user to interact with a communications system. The user terminal presents information to the user and allows the user to input information. In other words, the user terminal may be any terminal capable of receiving information from and/or transmitting information to the network, connectable to the network wirelessly or via a fixed connection. Examples of the user terminal include a multimedia device, personal computer, game console, laptop (notebook), personal digital assistant, mobile station (mobile phone), and line telephone.

The apparatus may be any node or network element (such as a base station), server or host that includes a detector.

The apparatus may be configured as a computer or a microprocessor, such as a single-chip computer element, including at least a memory for providing storage area used for arithmetic operation and an operation processor for executing the arithmetic operation. An example of the operation processor includes a central processing unit. The memory may be a removable memory detachably coupled to the apparatus.

The apparatus or parts of it may also be a chip-set or a module insertable in a server, node, host, user terminal, etc.

An embodiment provides a computer program embodied on a distribution medium, comprising program instructions which, when loaded into an electronic apparatus, constitute the apparatus as explained above. The computer program includes software routines, applets and macros, etc. The computer program may comprise program instructions for carrying out the method depicted by means of FIG. 2, or it may comprise program instructions for carrying out: calculating a symbol amplitude by using a predetermined filter coefficient vector and a predetermined channel response, determining a weighting factor by using the symbol amplitude, estimating soft bits, and weighting the estimated soft bits by using the weighting factor for scaling the estimated soft bits to a predetermined dynamic range.

The computer program may be in source code form, object code form, or in some intermediate form, and it may be stored in some sort of a carrier or a distribution medium, which may be any entity or device capable of carrying out the program. Such carriers include a record medium, computer memory, read-only memory, electrical carrier signal, telecommunications signal, and software distribution package, for example. Depending on the processing power needed, the computer program may be executed in a single electronic digital computer or it may be distributed amongst a number of computers.

The techniques described herein may be implemented by various means. For example, these techniques may be implemented in hardware (one or more devices), firmware (one or more devices), software (one or more modules), or combinations thereof. For a hardware implementation, the apparatus may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation can be carried out through modules of at least one chip set (e.g., procedures, functions, and so on) that perform the functions described herein. The software codes may be stored in a memory unit and executed by processors. The memory unit may be implemented within the processor or externally to the processor. In the latter case it can be communicatively coupled to the processor via various means, as is known in the art. Additionally, the components of systems described herein may be rearranged and/or complimented by additional components in order to facilitate achieving the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The invention and its embodiments are not limited to the examples described above but may vary within the scope of the claims.

1. An apparatus, comprising:
an estimator configured to estimate a channel response;
a determiner configured to determine an equalizer coefficient vector;
a calculator configured to calculate a symbol amplitude by using the equalizer coefficient vector and the estimated channel response;
a determiner configured to determine a weighting factor by using the symbol amplitude;
an estimator configured to estimate soft bits; and
a weighter configured to weight the estimated soft bits by using the weighting factor to scale the estimated soft bits in a manner enabling their presentation using a predetermined limited numerical accuracy.

2. The apparatus of claim 1, wherein the equalizer is a minimum mean-square error equalizer and the apparatus is further configured to calculate the symbol amplitude by taking a conjugate transpose of a linear minimum mean-square error equalizer coefficient vector and multiplying it by the channel frequency response.

3. The apparatus of claim 1, wherein the weighting factor is of the form:
$$\frac{{c}_{1}}{{c}_{2} - α A} ,$$
wherein
c₁ is a selectable parameter,
c₂ is another selectable parameter,
α is yet another selectable parameter, and
A is a symbol amplitude.

4. The apparatus of claim 1, wherein the weighting factor is of the form:
$$\frac{{c}_{1}}{{c}_{2} - α A} ,$$
wherein
c₁ is a selectable parameter,
c₂ is another selectable parameter,
α is yet another selectable parameter, and
A is a symbol amplitude,
the apparatus is further configured to adapt the value of c₁ according to a modulation method used.

5. The apparatus of claim 1, wherein the weighting factor is of the form:
$$\frac{{c}_{1}}{{c}_{2} - α A} ,$$
wherein
c₁ is a selectable parameter,
c₂ is another selectable parameter,
α is yet another selectable parameter, and
A is a symbol amplitude,
the apparatus is further configured to adapt the value of c₁ according to a signal-to-noise ratio for scaling the obtained soft bit values.

6. The apparatus of claim 1, wherein the weighting factor is of the form:
$$\frac{{c}_{1}}{{c}_{2} - α A} ,$$
wherein
c₁ is a selectable parameter,
c₂ is another selectable parameter,
α is yet another selectable parameter, and
A is a symbol amplitude, and
the term α is selected to be smaller than 1 to limit the range of the soft bits.

7. The apparatus of claim 1, wherein the apparatus is further configured to quantize the estimated soft bits using either linear or non-linear quantization.

8. The apparatus of claim 1, wherein the apparatus comprises a user terminal.

9. The apparatus of claim 1, wherein the apparatus comprises a network element.

10. A method, comprising:
estimating a channel response;
determining an equalizer coefficient vector;
calculating a symbol amplitude by using the equalizer coefficient vector and the estimated channel response;
determining a weighting factor by using the symbol amplitude;
estimating soft bits; and
weighting the estimated soft bits by using the weighting factor to scale the estimated soft bits in a manner enabling their presentation using a predetermined limited numerical accuracy.

11. The method of claim 10, wherein the equalizer is a minimum mean-square error equalizer and the method further comprises: calculating the symbol amplitude by taking a conjugate transpose of a linear minimum mean-square error equalizer coefficient vector and multiplying it by the channel frequency response.

12. The method of claim 10, wherein the weighting factor is of the form:
$$\frac{{c}_{1}}{{c}_{2} - α A} ,$$
wherein
c₁ is a selectable constant,
c₂ is another selectable constant,
α is yet another selectable constant, and
A is a symbol amplitude.

13. The method of claim 10, wherein the weighting factor is of the form:
$$\frac{{c}_{1}}{{c}_{2} - α A} ,$$
wherein
c₁ is a selectable parameter,
c₂ is another selectable parameter,
α is yet another selectable parameter, and
A is a symbol amplitude,
the method is further comprising:
adapting the value of c₁ according to a modulation method used.

14. The method of claim 10, wherein the weighting factor is of the form:
$$\frac{{c}_{1}}{{c}_{2} - α A} ,$$
wherein
c₁ is a selectable parameter,
c₂ is another selectable parameter,
α is yet another selectable parameter, and
A is a symbol amplitude,
the method is further comprising:
adapting the value of c₁ according to a signal-to-noise ratio for scaling obtained soft bit values.

15. The method of claims 10, wherein the weighting factor is of the form:
$$\frac{{c}_{1}}{{c}_{2} - α A} ,$$
wherein
c₁ is a selectable parameter,
c₂ is another selectable parameter,
α is yet another selectable parameter, and
A is a symbol amplitude,
the method is further comprising:
selecting the term α to be smaller than 1 to limit the range of the soft bits.

16. The method of claim 10, further comprising:
quantizating the estimated soft bits using either linear or non-linear quantization.

17. An apparatus, comprising:
estimating means for estimating a channel response;
determining means for determining an equalizer coefficient vector;
calculating means for calculating a symbol amplitude by using the equalizer coefficient vector and the estimated channel response;
determining means for determining a weighting factor by using the symbol amplitude;
estimating means for estimating soft bits; and
weighting means for weighting the estimated soft bits by using the weighting factor to scale the estimated soft bits in a manner enabling their presentation using a predetermined limited numerical accuracy.

18. The apparatus of claim 17, wherein the equalizer is a minimum mean-square error equalizer and the apparatus further comprises means for calculating the symbol amplitude by taking a conjugate transpose of a linear minimum mean-square error equalizer coefficient vector and multiplying it by the channel frequency response.

19. A computer program embodied on a computer-readable medium, the computer program being configured to control a processor to perform:
calculating a symbol amplitude by using a predetermined equalizer coefficient vector and a predetermined channel response;
determining a weighting factor by using the symbol amplitude;
estimating soft bits; and
weighting the estimated soft bits by using the weighting factor to scale the estimated soft bits in a manner enabling their presentation using a predetermined limited numerical accuracy.

20. The computer program of claim 19, further comprising:
calculating the symbol amplitude by taking a conjugate transpose of a linear minimum mean-square error equalizer coefficient vector and multiplying it by the channel frequency response.

21. The computer program of claim 19, wherein the weighting factor is of the form:
$$\frac{{c}_{1}}{{c}_{2} - α A} ,$$
wherein
c₁ is a selectable constant,
c₂ is another selectable constant,
α is yet another selectable constant, and
A is a symbol amplitude.

22. The computer program of claim 19, wherein the weighting factor is of the form:
$$\frac{{c}_{1}}{{c}_{2} - α A} ,$$
wherein
c₁ is a selectable parameter,
c₂ is another selectable parameter,
α is yet another selectable parameter, and
A is a symbol amplitude,
the computer program product is further comprising:
adapting the value of c₁ according to a modulation method used.

23. The computer program of claim 19, wherein the weighting factor is of the form:
$$\frac{{c}_{1}}{{c}_{2} - α A} ,$$
wherein
c₁ is a selectable parameter,
c₂ is another selectable parameter,
α is yet another selectable parameter, and
A is a symbol amplitude,
the method is further comprising:
adapting the value of c₁ according to a signal-to-noise ratio to scale obtained soft bit values.

24. The computer program of claim 19, wherein the weighting factor is of the form:
$$\frac{{c}_{1}}{{c}_{2} - α A} ,$$
wherein
c₁ is a selectable parameter,
c₂ is another selectable parameter,
α is yet another selectable parameter, and
A is a symbol amplitude,
the computer program product is further comprising:
selecting the term α to be smaller than 1 to limit the range of the soft bits.

25. The computer program of claim 19, further comprising:
quantizing the soft bits using either linear or non-linear quantization.
